(19) United States
(12) Patent Application Publication
(10) Pub. No.: US 2013/0039046 A1
(43) Pub. Date: Feb. 14, 2013

(54) APPARATUS AND METHOD FOR ELECTRIC CANDLES

(71) Applicant: Miryam Uzan, Bnei Brak (IL)

(72) Inventor: Miryam Uzan, Bnei Brak (IL)

(21) Appl. No.: 13/576,660

(22) PCT Filed: Jan. 25, 2011
(86) PCT No.: PCT/IB2011/050312

§ 371 Date: Oct. 14, 2012

Related U.S. Application Data
(60) Provisional application No. 61/300,478, filed on Feb. 2, 2010.

(51) Int. Cl. F21S 10/04; F21L 4/08; F21L 4/02

(52) U.S. Cl. 362/183; 362/184; 362/157

(57) ABSTRACT

It is disclosed an apparatus for electric candles, which includes electric power supply, connectable light emitters, flame sensors respectively proximate to the light emitters, and means for connecting a light emitter to the electric power supply in accordance with the sensed flames. The flame sensor may activate an electric switch connecting the power supply to the respective light emitter. The apparatus may include a control unit for receiving a flame detection signal, connecting a respective light emitter to the power supply, receiving control commands from an user interface, storing control commands, and turning off a light emitter in accordance with stored control commands. The user kindles fire on a flame carrier, bringing the flame to a flame sensor, the flame sensor detects the flame, and causes connecting to a power supply.

### BACKGROUND OF THE INVENTION

1. Field of the Invention

The invention is in the field of ceremonial and religious candles and in special deals with electric candles operated by the traditional act of kindling a match or a candle and using that flame source for turning on the candles.

2. Description of Related Art

For a matter of convenience the prior art is described in connection with Jewish religious tradition. However, similar prior art is known in other religions and in secular ceremonies worldwide, and the current invention is useful for these applications as well.

A stand alone candle on a candlestick as depicted in FIG. 1 is used in one's home to remember a passed away family member in the yearly day of the person's death, or in certain holidays like Yam Kippur or the festive of Shavuot. In public, such a candle is lighted in a memorial day for soldiers or people died in a tragic event of importance to the public. The memorial candle may be lighted in private or in a ceremony, usually during the evening, and stay burning for 24 hours.

To light or kindle a candle, one places the candle on a candlestick, kindles a match or a cigarette lighter, brings the flame close to the candle wick, increasing the temperature thereof such that a flame is ignited in the wick. The flames continues to light, as it is fed continuously by melted wax from the upper face of the candle by capillarity.

A pair of candles on respective candlesticks is shown in FIG. 2. Such a candle pair is lighted by a young married woman having no children each Friday just before sunset, in designation of the coming Shabbat. Occasionally, these candles reside on a dinner table and stay burning for several hours after sunset.

Upon having children, a Jewish woman traditionally kindles additional candle for each child. For convenience, a woman having a single child may use a three candle candelabrum as shown in FIG. 3.

Hanukkah is an eight day festive celebrating an historical event which occurred in the Jewish Temple of Jerusalem almost 2200 years ago. A nine candles candelabrum, as shown in FIGS. 4a and 4b, is used for lighting candles in each evening of the festive. In the first evening, a single candle is lighted by a serving candle grasped by the person in the left hand side of FIG. 4a, and each consecutive evening additional candle is appended, such as to light eight candles and a serving candle in the last evening of the festive as shown in FIG. 4b.

In the sixth day example of FIG. 4a, a person initially kindles a servant candle and then lights a candle at a time. In FIG. 4a four candles had already been lighted, and additional two candle are ready to be lighted. After lighting all the candles, the person puts the serving candle on its special place, the elevated central position for example.

Hanukkah candles stay burning for at least half an hour after sunset. Thus, their total lighting duration depends on kindling time. In weekdays, one kindles the candles after sunset and thus their total burning time should be half an hour, and regular

Hanukkah candles are made to provide slightly more than that minimal burning duration. However, in Friday the candles are kindled well before sunset as kindling is forbidden during the entering Shabbat according to religious rules. Thus, candles of longer burning time are used to provide the extra burning time.

Despite the beauty and fancy character of ceremonial candle lighting, there are some drawbacks of traditional candle lighting. First, sometimes candles reside at an unattended place after kindling, and may set fire in the place. For example, while spending a weekend vacation in an hotel, the religious rule calls for candle lighting in the hotel room as the sleeping place. However, such an action is prohibited as a fire hazard, and the prohibition is enforced by smoke detectors which activate fire alarm means like siren. Thus, the hotel visitors kindle Shabbat and/or memorial candles in a special public location allocated by hotel management, rather than doing it in their intimate room place.

Secondly, upon burning the candle melts some wax without burning it, such that it drops down on candlestick or candelabrum and should be removed later before a succeeding use.

Electric candles operated electrically by a push button or by a control means are well known in the prior art, which describe candles shaped and designed to simulate real candles. However, such electric candles fail to preserve a sense of the traditional candle lighting. Thus, it is an objective of the current invention to employ electric candles while preserving at least part of the experience of traditional candle kindling, by using a real flame during certain steps of candle lighting.

### BRIEF SUMMARY OF THE INVENTION

It is disclosed in accordance with preferred embodiments of the current invention, an apparatus for electric candles. The apparatus includes an electric power supply, light emitters connectable to the electric power supply, flame sensors respectively proximate to the light emitters, and means for connecting a light emitter to the electric power supply in accordance with a flame sensed by a respective flame sensor.

The electric power supply may be a battery, a rechargeable battery connected to an electric mains source or to an interface for connection to an electric mains source.

In some embodiments, the apparatus includes two light emitters, and two respective flame sensors. In alternative embodiments, the apparatus includes seven, eight or nine light emitters.

The flame sensor may be a thermocouple sensor, an infra-red sensor, a light sensor, an ultra-violet sensor, a pyroelectric detector or a smoke sensor.

In some embodiments, the flame sensor activates an electric switch which connects the power supply to the respective light emitter.

Exemplary light emitters are a diode light emitter, an incandescent light bulb, and a gas discharge lamp.

In some embodiments, the apparatus includes a control unit adapted for receiving a flame detection signal from a flame sensor, connecting a respective light emitter to the power supply in accordance with a received flame detection signal, receiving control commands from an user interface, storing control commands, and turning off a light emitter in accordance with stored control commands.

In some embodiments the apparatus further includes a user interface for receiving control commands from a user.

It is provided according to preferred embodiments of the current invention a method for electric candles. The method includes kindling fire on a flame carrier, bringing the flame close to a flame sensor, the flame sensor detecting the flame, and connecting a light emitter to a power supply in accordance with the detecting.

In some embodiments the method further includes the step of turning off the light emitter in accordance with a predetermined control command.

In some embodiments, the connecting of a light emitter to a power supply occurs after a predetermined delay since said detecting.

### BRIEF DESCRIPTION OF THE DRAWINGS

The subject matter regarded as the invention is particularly pointed out and distinctly claimed in the concluding portion of the specification. The invention, however, both as to system organization and method of operation, together with features and advantages thereof, may best be understood by reference to the following detailed description when read with the accompanied drawings in which:

FIG. 1 (prior art) illustrates a single candle on a candlestick.

FIG. 2 (prior art) illustrates a pair of candles on respective candlesticks for Sabbath candles or for a festive dinner.

FIG. 3 (prior art) depicts a three candle Sabbath candelabrum.

FIG. 4a (prior art) illustrates kindling six Hanukkah candles in a eight candles-one serving-candle candelabrum.

FIG. 4b(prior art) depicts a fully lighted Hanukkah candelabrum in the eighth evening of the Hanukkah festive.

FIG. 5 depicts an electric candle on candlestick according to one embodiment of the current invention.

FIG. 6 is a block diagram of an electric candlestick.

FIG. 7 is a block diagram of an electric candelabrum.

FIG. 8 is a flow chart of a method for electric candelabrum.

FIG. 9 is a flow chart of a method for a candelabrum control unit.

FIG. 10a is a block diagram of a coin operated memorial electric candlestick.

FIG. 10b illustrates a memorial electric candle having an associated digital frame.

FIG. 11 is a block diagram of an electric candle having an alternative light emitter.

FIG. 12 illustrates a memorial board having flame sensors for activating the memorial candles.

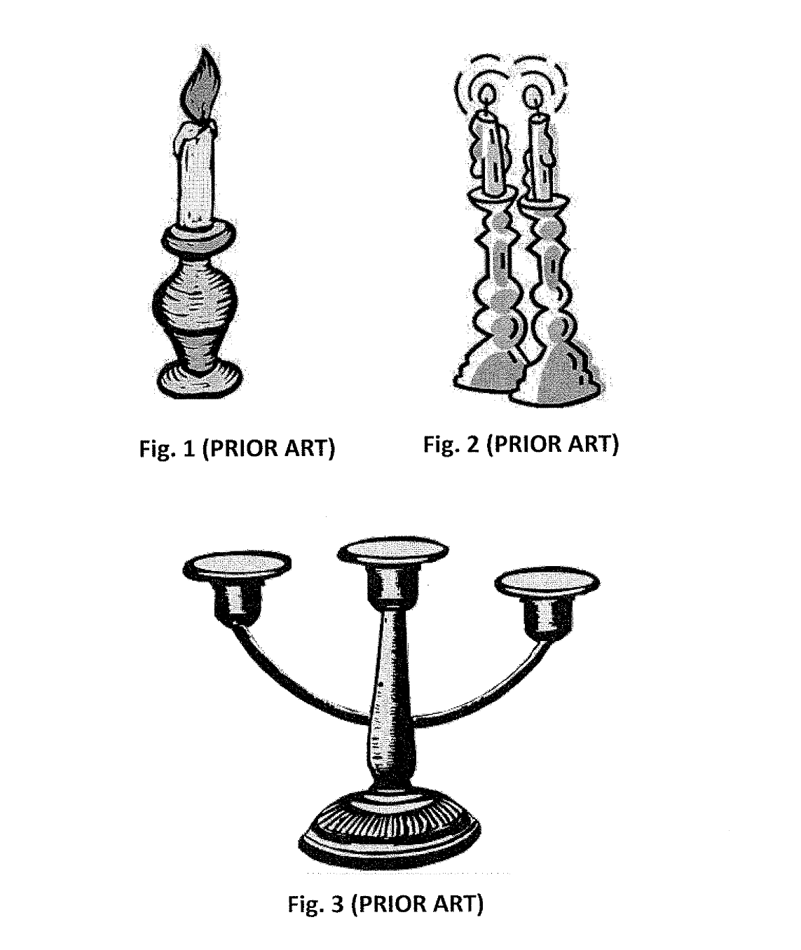

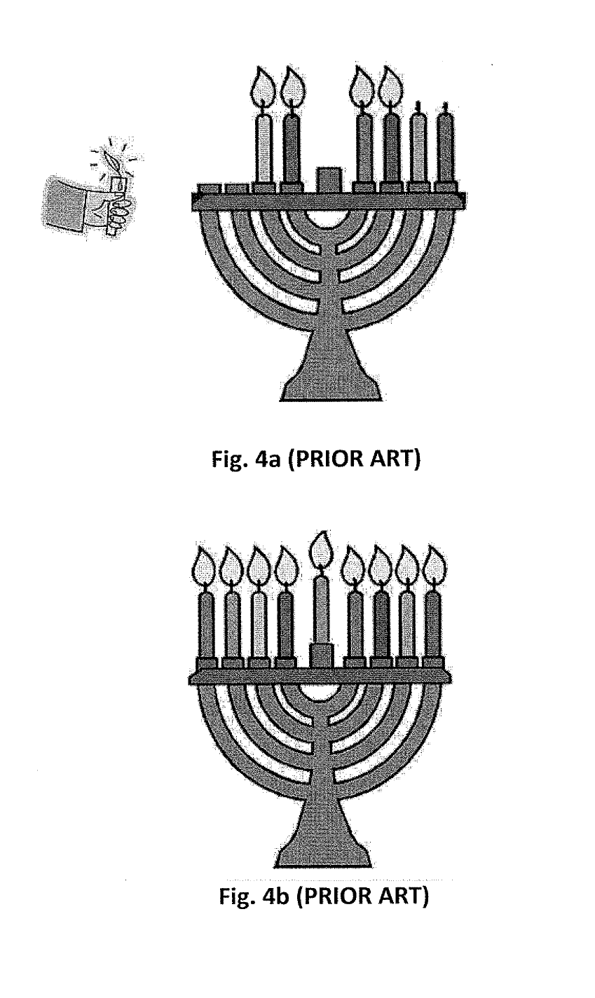

### DETAILED DESCRIPTION OF THE INVENTION

The present invention will now be described in terms of specific example embodiments. It is to be understood that the invention is not limited to the example embodiments disclosed. It should also be understood that not every feature of the methods and systems handling the described device is necessary to implement the invention as claimed in any particular one of the appended claims. Various elements and features of devices are described to fully enable the invention. It should also be understood that throughout this disclosure, where a method is shown or described, the steps of the method may be performed in any order or simultaneously, unless it is clear from the context that one step depends on another being performed first.

Before explaining several embodiments of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

Unless otherwise defined, all technical and scientific terms used herein have the same meaning as commonly understood by one of ordinary skill in the art to which this invention belongs. The systems, methods, and examples provided herein are illustrative only and not intended to be limiting.

In the description and claims of the present application, each of the verbs “comprise”, “include” and “have”, and conjugates thereof, are used to indicate that the object or objects of the verb are not necessarily a complete listing of members, components, elements or parts of the subject or subjects of the verb.

In general, the current invention provides an electric candle which is lighted in a way strongly resembling the traditional way of kindling candles, as described above. The user provides a real flame and brings it close to the candle, whereas a flame sensor senses the flame and consequently the electric candle starts to emit light.

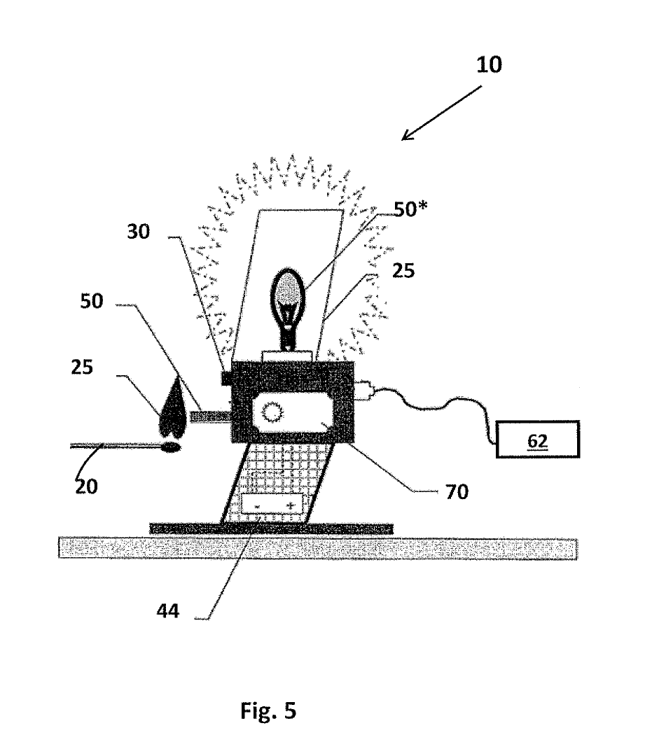

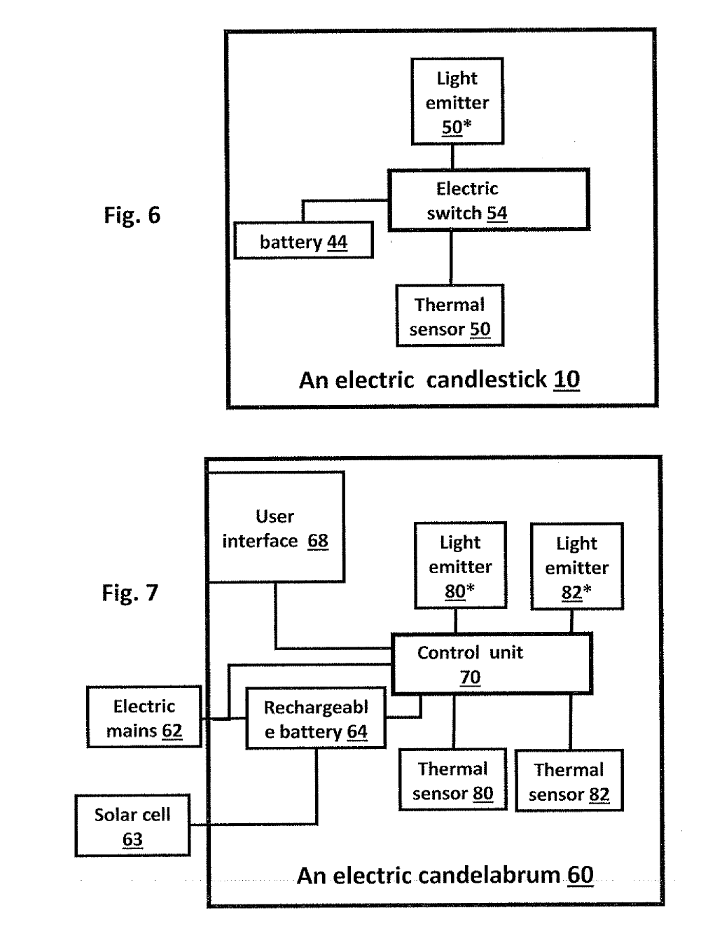

A typical apparatus 10 for an electric candle is illustrated in FIG. 5 and in the block diagram of FIG. 6. Apparatus 10 includes two electric power supplies, a cord connected to an electric mains 62 and a battery 44, an incandescent light bulb 50* electrically connectable to battery 44, a flame sensor 80 proximate to light bulb 50*, and a control unit 70 or electric switch 54 for connecting light bulb 50* to battery 44 in accordance with flames sensed by flame sensor 50.

To kindle bulb 50*, a user presses a button 30 to retract a flame sensor 80, lights a match 20, and brings a flame 25 of match 20 in contact or very close to flame sensor 80. As sensor 50 senses flame 25, it stimulates switch 54 to connect battery 44 to bulb 50*. As a result, bulb 50* heats up and emits light. Note that the human actions involved in kindling electric candle 50* of apparatus 10 overlaps appreciably the actions taken in kindling a regular candle.

Battery 44 may be a rechargeable battery charged by mains 62. Alternatively, mains 62 may provide electric power to bulb 50* through control unit 70, preferably at a reduced voltage.

FIG. 7 illustrates an electric candelabrum 60 which includes two flame sensors 80 and 82 and two respective light emitters 80* and 82. Flame sensor 80 may be a thermocouple sensor, an infra-red sensor, a visible light sensor, an ultra-violet sensor, a pyroelectric detector or a smoke sensor. Light emitter 80* may be a diode light emitter, an incandescent light bulb, or a gas discharge lamp.

Control unit 70 receives a flame detection signal from flame sensor 80 or 82, connects respective light emitter 80* or 82* to rechargeable battery 64 or electric mains 62 in accordance with the received flame detection signal, receives control commands from an user interface 68, stores control commands in either a internal memory(not shown) or an external memory(not shown), and turns off light emitter 80* in accordance with the stored control commands.

For example, an electric Hanukkah candelabrum of nine candles, eight daily candles and a serving candle, may have a control unit 70 for turning off the candles 80* and 82* at appropriate time. During Hanukkah weekday evenings the user feeds interface 68 with a control command for turning candles 80* and 82* off one hour after kindling. In contrast, in Friday evening the user feeds a command to turn off candles 80* and 82* two hours after kindling, such that they light at least an hour after sunset, as desired traditionally.

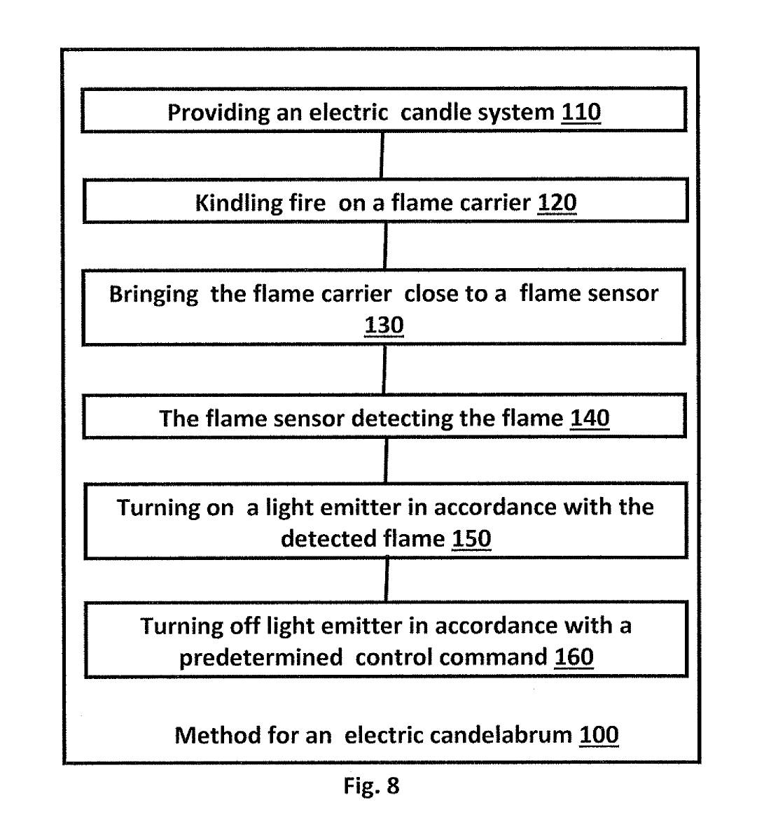

Referring now to the flowchart of FIG. 8, a method 100 for electric candles includes a step 110 of providing an electric candelabrum 60 or an electric candle system, a step 120 of kindling fire on a flame carrier 20, a step 130 of bringing flame 25 close to a flame sensor 50, a step 140 of detecting flame 25 by flame sensor 50, and a step 150 of connecting candles 80* and 82* to a power supply 62 in accordance with the detecting step 140, such that electric candles 80* and 82* turn on. Method 100 may also include a step 160 turning off candles 80* and 82* in accordance with a predetermined control command.

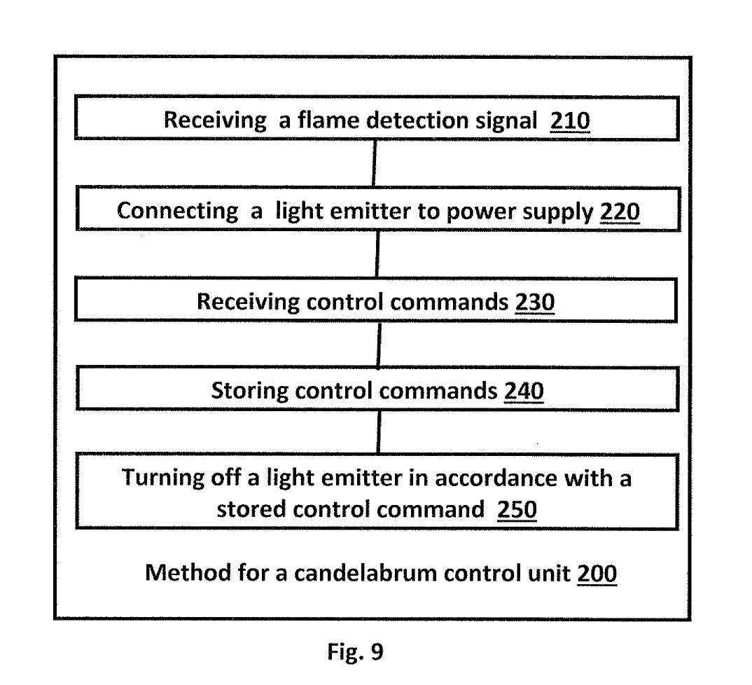

Control unit 70 implements a method 200 for controlling candelabrum 60, as depicted in the flowchart of FIG. 9. Method 200 includes a step 210 of receiving a flame detection signal from flame sensor 80, a step 220 of connecting a candle 80* to a power supply 62 in accordance with the detected flame signal, a step 230 of receiving control commands from a user interface 68, a step 240 of storing the received control command at either an internal or external memory, and a step 250 of turning off candle 80* in accordance with the stored control commands.

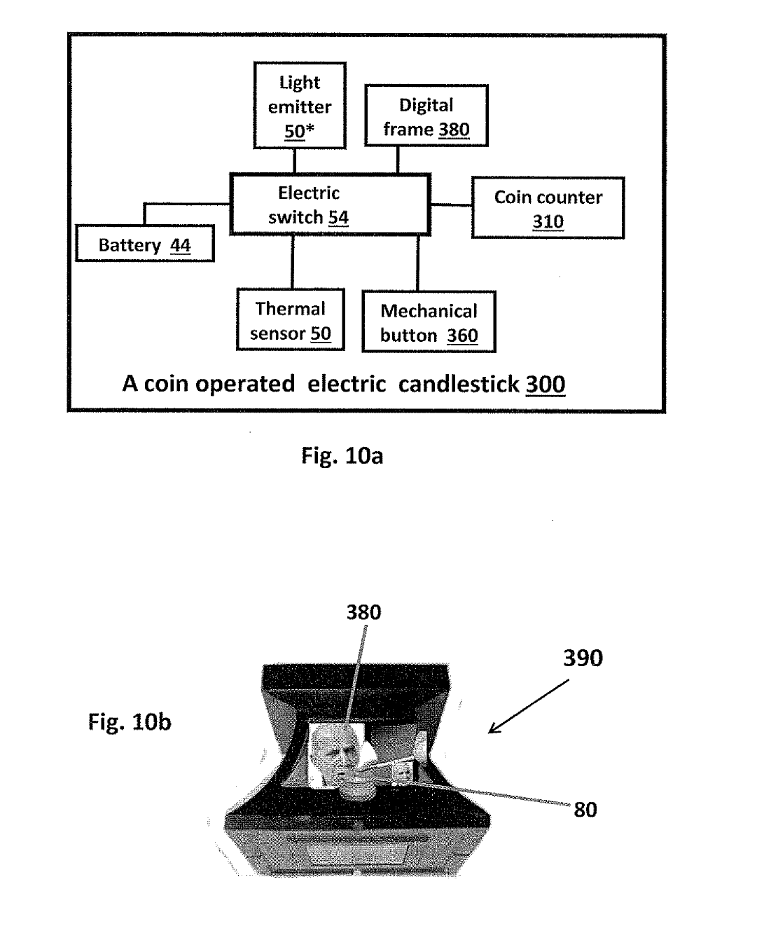

Referring now to FIG. 10a, a coin operated electric candlestick 300 is disclosed. Candlestick 300 is used as a memorial candle and may be available to people visiting their passed away relatives in a graveyard. To enable its operation, one puts coins in a coin counter 310, kindles a match 20 and brings a flame 25 close to thermal sensor 50, thus activates an electric switch 54 such that light emitter 50* is lighted for a certain time duration in accordance with the money received by coin counter 310. Preferably, coin counter 310 is configured to receive money using credit cards, cellular phones, electronic cards, or other means known in the art. Preferably, candlestick 300 has a mechanical button 360 for operating light emitter 50*. Button 360 may be used in case one has no matches, for example.

A digital frame 380 may be incorporated in a memorial candlestick 300, and may be activated by electric switch 54 or control unit 470 whenever light emitter 50* is activated. As shown in FIG. 10b, digital frame 380 is part of memorial candlestick 390 and it presents pictures of the dead and/or the living relatives, for example.

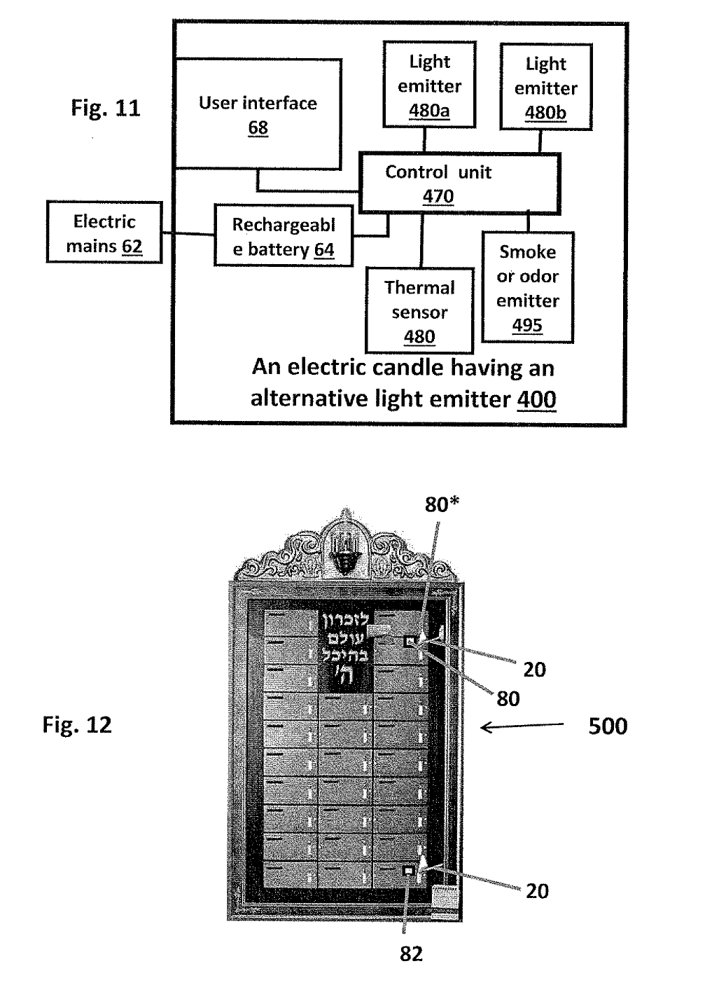

An electric candle 400 having an alternative light emitter for use whenever a default candle fails or becomes broken, is shown in FIG. 11. Initially, activating thermal sensor 480 leads to connecting of battery 64 to light emitter 480a through control unit 470 such that emitter 480a emits light. In case light emitter 480a fails, it interrupts to draw current from battery 64 and control unit 470 senses that current interruption and connects battery 64 to light emitter 480b.

Electric candle 400 may include also a smoke or odor emitter 495, activated whenever one of the light emitters is activated. Emitter 495 is designed much alike the design of an electronic cigarette which is well known in the art.

Referring now to FIG. 12, a memorial board 500 includes numerous electric candles, each for a passed away person with indication of the death yearly date or Yurzait. An electronic controller 70 or 470 may be used to light each candle in the respective death yearly date. Alternatively, a button is used light a respective electric candle. According to the current invention, a candle 80* has respective flame sensor 80, and in the yearly date a son of the dead person approaches the memorial board, usually placed in a synagogue, kindles a match 20, brings the flame close to sensor 80* and thus causing lighting of light emitter 80*. A control unit 470 has a digital clock to turn off the light after 24 hours.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. In particular, the present invention is not limited in any way by the examples described.

1. An apparatus for one or more electric candles comprising:
(a) at least one electric power supply;
(b) one or more light emitters electrically connectable to said at least one electric power supply;
(c) one or more flame sensors respectively proximate to said one or more light emitters; and
(d) means for connecting at least one of the light emitters to said at least one electric power supply in accordance with at least one flame sensed by a respective flame sensor.

2. The apparatus of claim 1 wherein the apparatus includes at least one electric power supply selected from the group of power supplies consisting of a battery, a rechargeable battery connected to an electric mains source, a rechargeable battery connected to a solar cell, and an interface for connection to an electric mains source.

3. The apparatus of claim 1 wherein the apparatus includes two light emitters, and two respective flame sensors.

4. The apparatus of claim I wherein the apparatus includes between seven and nine light emitters.

5. The apparatus of claim 1 wherein at least one flame sensor is selected from the group of flame sensors consisting of a thermocouple sensor, an infra-red sensor, a light sensor, a ultra-violet sensor, a pyroelectric detector, and a smoke sensor.

6. The apparatus of claim 1 wherein the apparatus includes a retractable flame sensor.

7. The apparatus of claim 1 wherein the flame sensor activates an electric switch connecting the power supply to the respective light emitter in accordance with sensing a flame by a flame sensor.

8. The apparatus of claim 1 wherein at least one of the light emitters is selected from the group of light emitters consisting of a diode light emitter, an incandescent light bulb, and a gas discharge lamp.

9. The apparatus of claim 1 wherein the apparatus includes a control unit adapted for at least one of:
(i) receiving a flame detection signal from a flame sensor;
(ii) connecting a respective light emitter to said at least one power supply in accordance with a received flame detection signal;
(iii) receiving control commands from an user interface;
(iv) storing control commands; and
(v) turning off a light emitter in accordance with stored control commands.

10. The apparatus of claim I wherein the apparatus further includes a user interface for receiving control commands from a user.

11. The apparatus of claim 1 wherein the apparatus further includes a coin counter for receiving payment means and enable light emitting in accordance with the received payment.

12. The apparatus of claim 1 wherein at least one light emitter is associated with a backing light emitter operable in case said one light emitter failed to provide light.

13. The apparatus of claim 1 wherein the apparatus further includes at least one additional accessory for operating in association with light emission by at least one light emitter of said one or more light emitters, said additional accessory selected from the group of accessories consisting of:
(A) a digital frame;
(B) a smoke emitter; and
(C) an odor emitter.

14. A method for electric candles comprising:
(a) kindling fire on a flame carrier;
(b) bringing the flame close to a flame sensor;
(c) the flame sensor detecting the flame;
(d) connecting a light emitter to a power supply in accordance with said detecting.

15. The method of claim 14 further includes the step of turning off the light emitter in accordance with a predetermined control command.

16. The method of claim 14 wherein said flame sensor is selected from the group of flame sensors consisting of a thermocouple sensor, an infra-red sensor, a light sensor, an ultra-violet sensor and a smoke sensor.

17. The method of claim 14 wherein said flame sensor activates an electric switch connecting the power supply to said light emitter.

18. The method of claim 14 wherein said connecting a light emitter to a power supply occurs after a predetermined delay since said detecting.

19. The method of claim 14 wherein the method is using a control unit adapted for at least one of:
(A) receiving a flame detection signal from said flame sensor;
(B) connecting said light emitter to said power supply in accordance with a received flame detection signal;
(C) receiving control commands from an operator interface;
(D) storing control commands; and
(E) turning off a light emitter in accordance with stored control commands.
